(19) United States
(12) Patent Application Publication
(10) Pub. No.: US 2007/0091153 A1
(43) Pub. Date: Apr. 26, 2007

(54) Biocidal print system components

(76) Inventor: James P. Shields, Philomath, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/257,619

(22) Filed: Oct. 25, 2005

(51) Int. Cl. B41J 2/175

(52) U.S. Cl. 347/86

(57) ABSTRACT

Incorporation of biocide into print system components, such as a metal ion biocide, facilitates reduced reliance on, and possible elimination of, biocides in marking fluid formulations. Such embodiments are especially useful in cationic marking fluid formulations where traditional marking fluid biocides may be incompatible. For some embodiments, the metal ion biocide is included in the marking fluid or incorporated into print system components that are only in intermittent contact with marking fluid.

### BACKGROUND

Biocides are routinely added to ink and other marking fluid formulations in order to mitigate growth of bacteria, fungi, mold and other such microbial organisms. However, regulatory or compatibility issues may limit the amount of biocide added to the marking fluid formulation. This may limit the useful shelf life of the marking fluid.

### BRIEF DESCRIPTION OF THE DRAWINGS

FIG. 1 is depiction of a carrier for a slow-release biocide for use with the various embodiments of the disclosure.

FIG. 2 is a cut-away perspective view of a marking fluid reservoir in accordance with one embodiment of the disclosure.

FIG. 3 is a block diagram of an imaging device in accordance with a further embodiment of the disclosure.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process, chemical, electrical or mechanical changes may be made without departing from the scope of the present disclosure. The following detailed description is, therefore, not to be taken in a limiting sense, and the scope of the present disclosure is defined by the appended claims and equivalents thereof.

The various embodiments involve incorporation of a biocide, such as a metal ion biocide, into one or more components of the printing system where ink contact may be found. For one embodiment, the metal ion biocide is a silver ion-containing compound including silver ions bonded to a zeolite carrier. As one example, the AgION™ antimicrobial compound available from AgION Technologies, Inc., Wakefield, Mass., USA, is a compound of silver ions bonded to a ceramic support structure. The structure allows the ions to be released at a slow and steady rate. Ambient moisture in the air can cause low-level release sufficient to provide biocidal effects. The ion exchange is increased in high humidity environments, where bacterial growth is often more prevalent. However, the interstices of the carrier limit the release of the silver ions such that long-term efficacy, perhaps years, can be achieved.

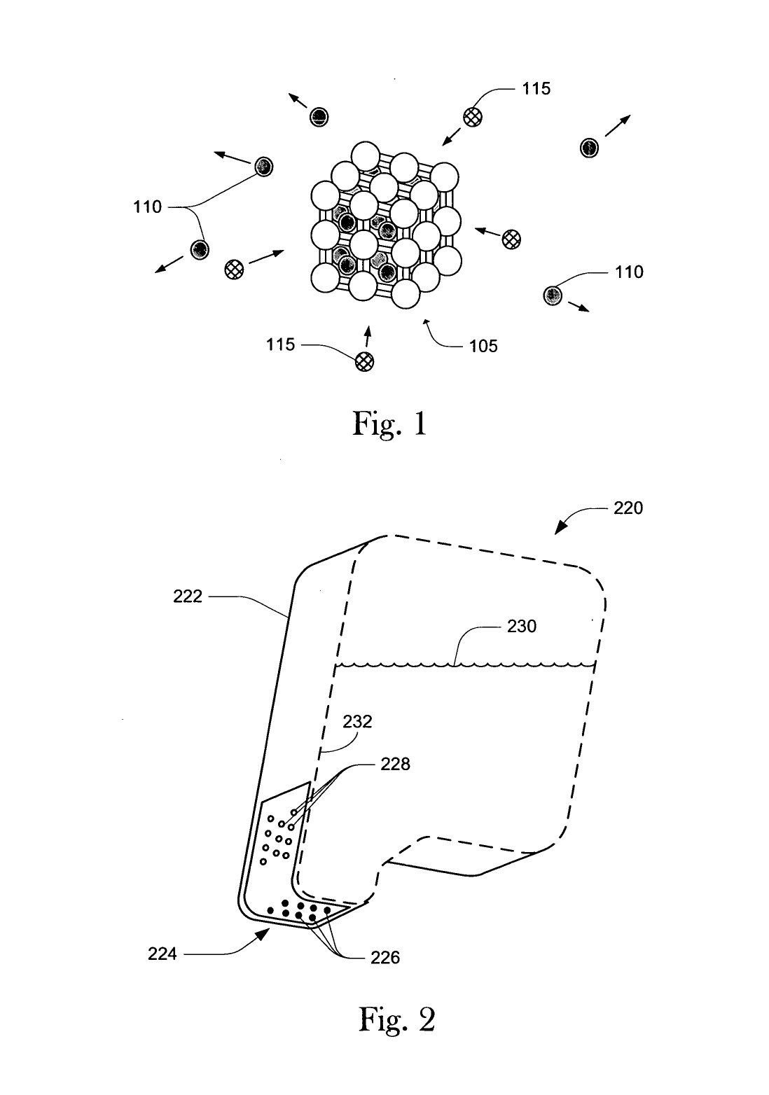

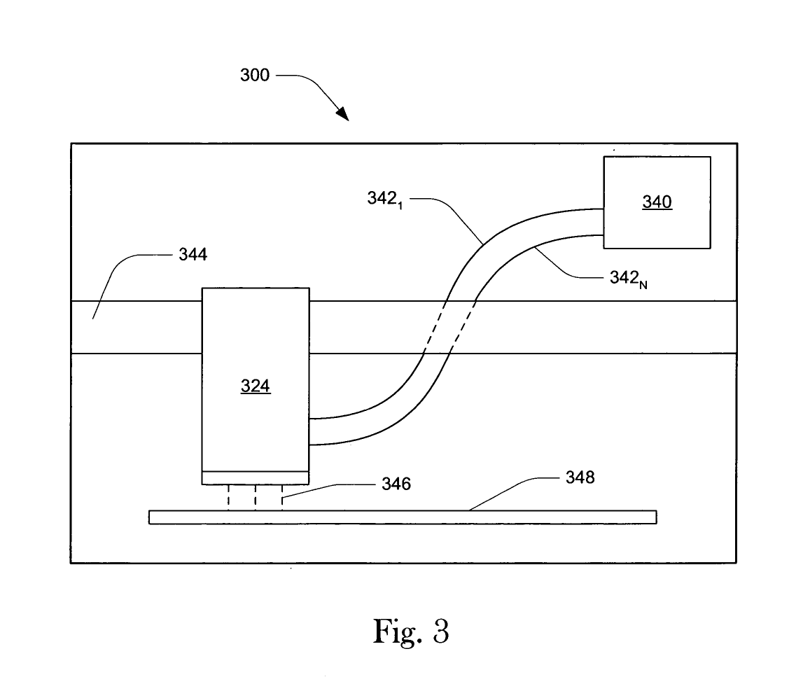

FIG. 1 is a depiction of a carrier for a slow-release biocide for use with the various embodiments of the disclosure. The carrier 105 is depicted as a zeolite structure having silver (Ag) ions 110. As ions 115, such as sodium (Na) ions, potassium (K) ions and/or lithium (Li) ions, present in ambient moisture or a marking fluid approach and contact the carrier 105, a non-reactive ion exchange occurs, releasing one or more of the silver ions 105. The silver ions 105 are an active biocide. Marking fluids generally contain some marking material, such as one or more dyes or pigments, for marking the medium, and some aqueous or solvent-based carrier vehicle to facilitate controlled ejection of the marking material.

An ink formulation was prepared for testing efficacy of the silver-ion biocide. The ink formulation is an amphoteric system which is positively charged at a pH of about 4-5. As tested, the ink formulation had a pH of approximately 4, making it cationic. The ink formulation contained, approximately, 3.5 wt % carbon black dispersion, 8 wt % 1,1,1-tris(hydroxymethyl)propane, 4 wt % glycerol ethoxylate, and 0.4 wt % propylene glycol butyl ether in an aqueous carrier. The biocide was used in the form of pellets containing approximately 20 wt % of the AgION™ antimicrobial compound in high-impact polystyrene (HIPS). Differing levels of the biocidal pellets were added to the ink formulations before inoculating the ink formulation with a microbe cocktail containing Bacillus subtilis, Pseudomonas cepacia, Candidas albicans and Aspergillus niger, and allowed to incubate for up to two weeks. Aliquots were removed from the test solutions at intervals and plated out on to an Agar dish, which was then placed in an oven to help further organism growth. The colonies on the Agar dish were then counted and compared against a control without a biocidal component added. Table 1 represents data obtained from such a testing procedure.

TABLE 1

| | |
|---|---|
| | AgION ™ compound added to ink |
| Ink | (g/100 g of ink) |

| Day | 0 | 8 | 16 | 32 |
|---|---|---|---|---|
| 0 | 41500 | 64000 | 43000 | 80000 |
| 1 | 550 | 460 | 420 | 30 |
| 3 | 655 | 305 | 83 | 0 |
| 7 | 350 | 215 | 55 | 0 |
| 15 | 320 | 11 | 0 | 0 |

As can be seen from Table 1, significant and rapid reductions in plate counts can be achieved with 16 g of the HIPS pellets with 20 wt % AgION™ compound per 100 g of the tested ink formulation. Although the example of Table 1 corresponds to an acidic marking fluid, i.e., pH<7, marking fluids with pH>=7 may also be used.

Print system components are commonly constructed of resins, plastics, elatomers and the like. Some examples include bonded nylon fiber; bonded polyester fiber; Delrin® synthetic resin; terpolymers of ethylene, propylene, and a non-conjugated diene; PET (polyethylene terephthalate); polyimides; polyurethanes; polypropylenes; polyethylenes; polysulfones; polyesters; Santoprenes thermoplastic elastomer; isoprene; Teflon® fluorine-containing resins; and the like. Slow-release biocides of the type described may be incorporated within such resins, plastics and elastomers at levels sufficient to provide efficacy against microbial growth without materially degrading their structural integrity. Alternatively, such slow-release biocides may be coated onto these materials as well as other materials of construction, such as metals, e.g., stainless steel, ceramics, e.g., aluminum oxide, and the like. By incorporating inorganic biocides into the materials used to form print system components that are likely to contact marking fluid during storage and delivery, or adhering the biocides to such surfaces of the print system components, the inclusion of biocides within the marking fluid formulation may be reduced or eliminated, thus facilitating the development of a wider variety of marking fluid formulations.

One common form of print system component is a replaceable pen for inkjet printers. These pens commonly provide both storage and delivery of the ink to a substrate. Returning to the testing detailed in Table 1, as the surface area of 16 g of the tested HIPS pellets corresponds roughly to an internal surface area of an inkjet pen of dimension 2.5 cm×2.5 cm×4.5 cm, it can be seen that a pen body formed of plastics containing the AgION™ compound can be efficacious at controlling microbial growth in the contained ink. Empirically, for one embodiment, an amount of silver ion in resin for formation of a print system component might be expressed as:
C(Ag)>=0.01*[Mᵢₙₖ/Mᵣₑₛᵢₙ]
where C(Ag) is the wt % of silver in resin used to form the print system component;

Mᵢₙₖ=mass of the ink in contact with the print system component; and

Mᵣₑₛᵢₙ=mass of the resin used to make the print system component.

Note, however, that such an empirical equation is to be used as guidance only. Efficacy may need to be tested in conditions simulating actual use.

FIG. 2 is a cut-away perspective view of one such pen, or marking fluid reservoir, 220 in accordance with one embodiment of the disclosure. The marking fluid reservoir 220 includes a body 222. A fluid ejection device or printhead 224 is integral to the body 222. The printhead 224 includes marking fluid ejectors 226 for dispensing marking fluid onto a print media or other substrate. The marking fluid ejectors 226 are controlled by various electrical signals received at one or more contacts 228.

The volume within the body 222 is adapted to contain marking fluid 230, e.g., ink. The cut-away portion of the body 222 represented by dashed lines may represent the cross-section of a one-color marking fluid reservoir or an individual chamber of a multi-color marking fluid reservoir, with each chamber having a different marking fluid formulation. Thus, the various embodiments include one-color and multi-color marking fluid reservoirs 220. The body 222 includes a biocide adhered to, or incorporated within, an inner surface 232 configured to be in contact with the marking fluid 230. For one embodiment, the biocide is a metal ion-containing material. For a further embodiment, the biocide is a ceramic zeolite structure having silver ions bonded thereto. For an alternate embodiment, a metal ion-containing support structure is added directly to the marking fluid 230.

In addition to a wall of the body 222 itself, the inner surface 232 may also include structures enclosed within the body 222. For example, back-pressure within a marking fluid reservoir 220 may be controlled using reticulated foam or other filler material of controlled capillary force, or bladders or spring bags may also be used to control flow.

While such integrated pens for storage and delivery of marking fluid are common in the consumer market, storage and delivery need not be combined. FIG. 5 illustrates an imaging device 300, such as a printer, according to another embodiment of the disclosure. Imaging device 300 has a fluid handling system that includes a fluid-ejection device 324, such as an inkjet print head, in flow communication with a stationary marking fluid reservoir 340, e.g., an ink reservoir, by one or more conduits 342. Fluid-ejection device 324 is movably attached to a rail or other support 344. Fluid-ejection device 324 can eject marking fluid droplets 346, such as ink droplets, onto a substrate 348, e.g., paper, as fluid-ejection device 324 moves across substrate 348.

For one embodiment, fluid reservoir 340 is fixedly attached to printer 300. For another embodiment, each of conduits 342 conveys a different fluid, e.g., a different colored ink, from fluid reservoir 340 to fluid-ejection device 324. For another embodiment, a portion of conduits 342 are fluid delivery lines that respectively convey different fluids to fluid-ejection device 324 and another portion of conduits 342 are fluid return lines for conveying fluids that are not ejected by fluid-ejection device 324 back to fluid reservoir 340.

For various embodiments, one or more of the fluid-ejection device 324, conduits 342 and fluid reservoir 342 include a biocide adhered to, or incorporated within, an inner surface configured to be in contact with the marking fluid.

Oftentimes, components for transporting marking fluid in systems such as printer 300 are normally empty and contain marking fluid only intermittently during transport from the reservoir 340 to the fluid-ejection device 324. For example, fluid-ejection device 324 may contain an integral reservoir (not shown) and the conduits 342 may only be in contact with marking fluid when re-filling the integral reservoir of the fluid-ejection device 324 and may be flushed or otherwise emptied of marking fluid upon completion of the re-filling operation. It is noted that the conduits 342 may represent components in addition to mere tubing, such as fittings, filters, check valves and the like. Any or all components of such conduits 342 may include a biocide adhered to, or incorporated within, an inner surface configured to be in intermittent contact with the marking fluid. Including a biocide in such components subject to only intermittent contact with marking fluid may lead to extended efficacy of the biocidal system.

What is claimed is:

1. A print system component, comprising:
a body for enclosing or transporting a marking fluid, the body having an inner surface for contact with the marking fluid;
wherein the inner surface contains a biocide incorporated within or adhered thereto.

2. The print system component of claim 1, wherein the body is selected from the group consisting of a marking fluid reservoir having an integrated fluid ejection device, a marking fluid reservoir without an integrated fluid ejection device, a fluid ejection device and a conduit of the print system.

3. The print system component of claim 1, wherein the biocide is a metal ion-containing compound.

4. The print system component of claim 3, wherein the metal ion-containing compound comprises a zeolite structure containing silver ions bonded thereto.

5. The print system component of claim 4, wherein the body is formed of a material having an amount of the zeolite structure efficacious to provide biocidal activity to the inner surface of the body.

6. The print system component of claim 5, wherein the material is selected from a group consisting of resins, plastics, elastomers, metals and ceramics.

7. An inkjet pen, comprising:
a body for enclosing ink and having an inner surface in contact with the ink;
a printhead integral to the body;
wherein the body is formed of a material containing metal ions capable of ion exchange when in contact with the ink.

8. The inkjet pen of claim 7, wherein the body is formed of a plastic, resin or elastomer containing silver ions bonded to a ceramic zeolite structure.

9. The inkjet pen of claim 8, wherein the plastic, resin or elastomer contains an amount of the zeolite structure efficacious to provide biocidal activity to the inner surface of the body.

10. The inkjet pen of claim 7, further comprising:
ink enclosed within the body.

11. The inkjet pen of claim 10, wherein the ink has a pH below 7.

12. The inkjet pen of claim 11, wherein the ink is substantially devoid of a biocidal component.

13. A method of controlling microbial growth in marking fluids, comprising:
contacting the marking fluid with a surface of a print system component;
wherein the surface of the print system component comprises a material having a metal ion biocide incorporated within or adhered thereto.

14. The method of claim 13, wherein contacting the marking fluid with a surface of a print system component further comprises contacting the surface of the print system component with marking fluid only intermittently.

15. The method of claim 13, wherein the print system component is selected from the group consisting of a marking fluid reservoir having an integrated fluid ejection device, a marking fluid reservoir without an integrated fluid ejection device, a fluid ejection device and a conduit of the print system.

16. The method of claim 13, wherein the metal ion biocide is a silver ion-containing compound.

17. The method of claim 16, wherein the silver ion-containing compound comprises a zeolite structure containing silver ions bonded thereto.

18. An imaging device, comprising:
a fluid ejection device having an inner surface for contact with a marking fluid; and
a marking fluid reservoir in flow communication with the fluid ejection device and having an inner surface for contact with the marking fluid;
wherein at least one of the inner surface of the fluid ejection device and the inner surface of the marking fluid reservoir comprises a metal ion biocide incorporated within or adhered thereto.

19. The imaging device of claim 18, wherein the fluid ejection device is integral with the marking fluid reservoir.

20. The imaging device of claim 18, wherein the metal ion biocide comprises a zeolite structure containing silver ions bonded thereto.

21. An imaging device, comprising:
a fluid ejection device having an inner surface for contact with a marking fluid;
a marking fluid reservoir and having an inner surface for contact with the marking fluid; and
one or more conduits for transporting marking fluid from the marking fluid reservoir to the fluid ejection device and having at least one inner surface for contact with the marking fluid;
wherein at least one of the inner surface of the fluid ejection device, the inner surface of the marking fluid reservoir and the at least one inner surface of the one or more conduits comprises a metal ion biocide incorporated within or adhered thereto.

22. The imaging device of claim 21, wherein the inner surface of a first conduit is adapted to be normally empty during operation of the imaging device.

23. The imaging device of claim 22, wherein the inner surface of the first conduit comprises the metal ion biocide incorporated within or adhered thereto.

24. The imaging device of claim 21, wherein the inner surfaces of a plurality of the one or more conduits are each adapted to be normally empty during operation of the imaging device.

25. The imaging device of claim 24, wherein the inner surfaces of the plurality of conduits each comprise the metal ion biocide incorporated within or adhered thereto.

26. The imaging device of claim 21, wherein the metal ion biocide comprises a zeolite structure containing silver ions bonded thereto.

27. A print system component, comprising:
means for enclosing or transporting a marking fluid; and
means for providing metal ion exchange with the marking fluid when the marking fluid is in contact with the means for enclosing or transporting.

28. The print system component of claim 27, wherein the means for enclosing or transporting a marking fluid is selected from the group consisting of a marking fluid reservoir having an integrated fluid ejection device, a marking fluid reservoir without an integrated fluid ejection device, a fluid ejection device and a conduit of the print system.

29. The print system component of claim 27, wherein the means for providing metal ion exchange with the marking fluid comprises a material of construction of the means for enclosing or transporting.

30. The print system component of claim 29, wherein the means for providing metal ion exchange further comprises means for exchanging sodium ions from the marking fluid with the metal ions.

31. A marking fluid, comprising:
a marking material;
a carrier vehicle; and
a metal ion-containing compound.

32. The marking fluid of claim 31, wherein the metal ion-containing compound comprises a zeolite structure containing silver ions bonded thereto.

33. The marking fluid of claim 31, wherein the making fluid contains an amount of the metal ion-containing compound efficacious to provide biocidal activity to the marking fluid.
